(19) United States
(12) Patent Application Publication
(10) Pub. No.: US 2019/0173126 A1
(43) Pub. Date: Jun. 6, 2019

(54) ELECTROLYTE FOR LITHIUM METAL BATTERY AND LITHIUM METAL BATTERY COMPRISING SAME

(71) Applicant: Samsung SDI Co., Ltd., Yongin-si Gyeonggi-do (KR)

(72) Inventors: Bokkyu JEON, Yongin-si (KR); Junghyun NAM, Yongin-si (KR); Hoon SEOK, Yongin-si (KR); Yeonjoo CHOI, Yongin-si (KR)

(21) Appl. No.: 16/320,986

(22) PCT Filed: Jul. 12, 2017
(86) PCT No.: PCT/KR2017/007485

§ 371 Date: Jan. 25, 2019

(30) Foreign Application Priority Data
Jul. 28, 2016 (KR) 10-2016-0096125

(51) Int. Cl. H01M 10/0561; H01M 10/052

(52) U.S. Cl. CPC H01M 10/0561; H01M 2300/002; H01M 10/052

(57) ABSTRACT

Provided are an electrolyte for a lithium metal battery and a lithium metal battery including the electrolyte, wherein the electrolyte includes: first inorganic particles having an average size of about 10 nm to about 100 nm; second inorganic particles having a average size larger than the average size of the first inorganic particles; an ion-conductive polymer; and a lithium salt, wherein a size ratio of the first inorganic particles to the second inorganic particles is about 1:9 to about 1:20.

### TECHNICAL FIELD

The present disclosure relates to an electrolyte for a lithium metal battery and a lithium metal battery comprising the electrolyte.

### BACKGROUND ART

Lithium secondary batteries are high-performance batteries having the highest energy density as compared with other types of commercially available secondary batteries, and are applicable to various fields including, for example, electric vehicles.

A lithium secondary battery may use a lithium metal thin film as a negative electrode. When a lithium metal thin film is used as a negative electrode, the negative electrode may strongly react with a liquid electrolyte during charging or discharging of the battery due to the high reactivity between the lithium metal and the electrolyte. In addition, dendritic growth may occur on the lithium metal thin film used as the negative electrode. Accordingly, a lithium secondary battery including a lithium metal thin film may have reduced lifespan and stability. Therefore, there is a need for a lithium secondary battery having improved properties.

### DESCRIPTION OF EMBODIMENTS

### Technical Problem

The present disclosure provides an electrolyte for a lithium metal battery.

The present disclosure provides a lithium metal battery having improved cell performance through suppression of lithium dendrite growth on a surface of a lithium metal negative electrode by use of the above-described electrolyte.

### Solution to Problem

According to an aspect of the present disclosure, there is provided an electrolyte for a lithium metal battery, the electrolyte including: first inorganic particles having an average size of about 10 nm to about 100 nm; second inorganic particles having an average size larger than the average size of the first inorganic particles; an ion-conductive polymer; and a lithium salt, wherein a size ratio of the first inorganic particles to the second inorganic particles is about 1:9 to about 1:20.

According to another aspect of the present disclosure, there is provided a lithium metal battery including the above-described electrolyte.

### Advantageous Effects of Disclosure

According to one or more embodiments, an electrolyte for a lithium metal battery may effectively suppress lithium dendrite growth on a surface of the lithium metal negative electrode, thus leading to a reduced lithium deposition density. As a result, a lithium metal battery having improved lifespan may be manufactured using the electrolyte.

### BRIEF DESCRIPTION OF DRAWINGS

FIG. 1 is a schematic cross-sectional view illustrating a structure of a lithium metal battery according to an embodiment;

FIGS. 2 and 3 are plots illustrating changes in voltage and current with respect to time in lithium metal batteries manufactured according to Example 1 and Comparative Example 1, respectively; and

FIG. 4 is a plot illustrating capacity-voltage profiles in lithium metal batteries manufactured according to Example 2 and Comparative Example 2.

### BEST MODE

According to an aspect of the present disclosure, an electrolyte for a lithium metal battery includes: first inorganic particles having an average size of about 10 nm to about 100 nm; second inorganic particles having an average size larger than the average size of the first inorganic particles; an ion-conductive polymer; and a lithium salt, wherein a size ratio of the first inorganic particles to the second inorganic particles is about 1:9 to about 1:20.

According to another aspect of the present disclosure, a lithium metal battery includes the above-described electrolyte.

### MODE OF DISCLOSURE

Hereinafter, example embodiments of an electrolyte for a lithium metal battery, a lithium metal battery and a method of manufacturing the lithium metal battery will be described in greater detail with reference to the appended drawings.

According to an aspect of the present disclosure, there is provided an electrolyte for a lithium metal battery, the electrolyte including: first inorganic particles having an average size of about 10 nm to about 100 nm; second inorganic particles having an average size larger than the average size of the first inorganic particles; an ion-conductive polymer; and a lithium salt, wherein a size ratio of the first inorganic particles to the second inorganic particles is about 1:9 to about 1:20.

The average size of the first inorganic particles may be about 10 nm to about 1000 nm, for example, about 20 nm to about 100 nm. The average size of the second inorganic particles may be about 300 nm to about 3000 nm, for example, about 400 nm to about 500 nm.

A total amount of the first inorganic particles and the second inorganic particles is about 1 part to about 40 parts by weight, for example, about 10 parts to about 30 parts by weight, with respect to 100 parts by weight of the ion-conductive polymer. When the total amount of the first inorganic particles and the second inorganic particles is within these ranges, an effect of suppressing dendrite growth on a surface of a lithium metal negative electrode may be excellent without deterioration of film-forming properties of the electrolyte.

As used herein, the term “size” may have a slightly different meaning depending on the shape of the inorganic particles. For example, the term “size” may refer to an average particle diameter when the inorganic particles are spherical, or may refer to a length of the major axis when the inorganic particles have, for example, a rectangular shape.

A lithium metal or a lithium metal alloy has a large electric capacity per unit weight, and thus it is possible to implement a high-capacity battery with the lithium meal or lithium metal alloy.

However, the lithium metal or lithium metal alloy may cause a short circuit between a positive electrode and a negative electrode due to the dendrite growth during dissolution/deposition of lithium ions. To address the problem of a short circuit caused by dendrites, the present disclosure suggests adding and dispersing bimodal inorganic particles in an electrolyte to increase tortuosity. The increased tortuosity may suppress lithium dendrite growth on the lithium metal negative electrode.

In one or more embodiments, the electrolyte may include an ion-conductive polymer, the first inorganic particles, the second inorganic particles, and a lithium salt.

The ion-conductive polymer may impart ionic conductivity to the electrolyte and at the same time have elasticity and strength to enable the electrolyte to maintain a film shape. In addition, dispersibility is excellent, and thus, the inorganic particles are able to be uniformly distributed. The ion-conductive polymer may be any material commonly used in lithium metal batteries. For example, the ion-conductive polymer may be at least one selected from the group consisting of polyvinylidene fluoride (PVDF), polyethylene oxide (PEO), polymethylene methacrylate (PMMA), and thermoplastic polyurethane (TPU).

In one or more embodiments, the thermoplastic polyurethane (TPU) may be a poly(dialkylene ester) thermoplastic polyurethane obtained by reaction of a poly(dialkylene ester) polyol intermediate with diisocyanate.

The poly(dialkylene ester) thermoplastic polyurethane may be prepared by reaction of at least one poly(dialkylene ester) polyol intermediate with at least one diisocyanate and at least one chain extender. The poly(dialkylene ester) polyol intermediate may include an intermediate derived from at least one dialkylene glycol and at least one dicarboxylic acid or an ester or anhydride thereof.

Examples of the diisocyanate may include 4,4′-methylenebis-(phenylisocyanate); hexamethylene diisocyanate; 3,3′-dimethylbiphenyl-4,4′-diisocyanate; m-xylylene diisocyanate; phenylene-1,4-diisocyanate; naphthalene-1,5-diisocyanate; diphenylmethane-3,3′-dimethoxy-4,4′-diisocyanate; toluene diisocyanate; isophorone diisocyanate; 1,4-cyclohexyl diisocyanate; decane-1,10-diisocyanate; dicyclohexylmethane-4,4′-diisocyanate; or a combination thereof.

Example of the chain extender may include hydroquinone bis(beta-hydroxyethyl)ether; ethylene glycol; diethylene glycol; propylene glycol; dipropylene glycol; 1,4-butanediol; 1,6-hexanediol; 1,3-butanediol; 1,5-pentanediol; di(hydroxyethyl) ether; neopentyl glycol; or a combination thereof.

The poly(dialkylene ester) polyol intermediate may include, for example, poly(diethylene glycol adipate).

In one or more embodiments, the diisocyanate may include 4,4′-methylenebis-(phenylisocyanate), and the chain extender may include butanediol, benzene glycol, or a combination thereof.

The thermoplastic polyurethane (TPU) may be prepared from a polyester polyol component essentially free of a polyether polyol.

In one or more embodiments, the poly(dialkylene ester) polyol intermediate, may be poly(diethylene glycol adipate), the diisocyanate may be 4,4′-methylenebis-(phenyl isocyanate), and the chain extender may be butanediol, benzene glycol, or a combination thereof.

The polyvinylidene fluoride (PVDF) may be, for example, a chlorotrifluoroethylene-vinylidene fluoride (CTFE-VDF) copolymer including about 15% by weight (wt %) to about 20 wt % of CTFE, or a hexafluoropropylene-vinylidene fluoride (HFP-VDF) copolymer including about 4 wt % to about 12 wt % of HFP.

The ion-conductive polymer may have a weight average molecular weight of about 10,000 Daltons or greater, and in some embodiments, about 10,000 Daltons to about 500,000 Daltons, and in some embodiments, about 15,000 Daltons to about 400,000 Daltons. When an ion conductive polymer having a weight average molecular weight within these ranges is used, an electrolyte having improved ductility, elasticity and strength characteristics may be obtained.

The first or second) inorganic particles may be, for example, at least one selected from Al₂O₃, TiO₂, BaTiO₃, Li₂O, LiF, LiOH, Li₃N, BaO, Na₂O, Li₂CO₃, CaCO₃, LiAlO₂, SiO₂, SiO, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, Sn₂BPO₆, a cage-structured silsesquioxane, and a metal-organic framework (MOF).

The lithium salt may provide lithium ions to the ion-conductive polymer to enable the polymer membrane to serve as an electrolyte. Non-limiting examples of the lithium salt may be at least one selected from LiPF, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein x and y are natural numbers), LiCl, and LiI. An amount of the lithium salt may be about 10 parts to about 70 parts by weight, for example, about 20 parts to about 50 parts by weight, with respect to 100 parts by weight of the ion-conductive polymer. When the amount of the lithium salt is within these ranges, the electrolyte may have improved ionic conductivity.

The electrolyte may have a thickness of about 1 μm to about 20 μm. When the thickness of the electrolyte is within this range, the electrolyte may have improved ionic conductivity and an improved dendrite suppression effect.

In one or more embodiments, the electrolyte may further include at least one selected from an organic solvent, an ionic liquid and a polymeric ionic liquid. The electrolyte may have a thickness of about 1 μm to about 20 μm.

In one or more embodiments, the first inorganic particles in the electrolyte may have an average size of about 20 nm, and the second inorganic particles in the electrolyte may have an average size of about 0.4 μm to about 0.5 μm (about 400 nm to about 500 nm).

Hereinafter, a method of preparing an electrolyte for a lithium metal battery according to any of the embodiments will be described.

First, an ion-conductive polymer, a lithium salt, first inorganic particles, and second inorganic particles as described above may be mixed together to obtain an electrolyte composition. An organic solvent may be further added into the electrolyte composition. The organic solvent may be any organic solvent available in the art. For example, the organic solvent may be tetrahydrofuran, N-methyl pyrrolidone, acetonitrile, benzonitrile, 2-methyltetrahydrofuran, γ-butyrolactone, dioxolane, 4-methyldioxolane, N,N-dimethylformamide, N,N-dimethylacetamide, N,N-dimethylsulfoxide, dioxane, 1,2-dimethoxyethane, sulfolane, dichloroethane, chlorobenzene, nitrobenzene, diethylene glycol, dimethyl ether, or a mixture thereof. An amount of the organic solvent may be about 100 parts to about 3000 parts by weight with respect to 100 parts by weight of the ion-conductive polymer.

In one or more embodiments, at least one selected from an ionic liquid and a polymeric ionic liquid may be further added to the electrolyte composition.

When forming an electrolyte with the electrolyte composition, the electrolyte composition may be coated on at least part of a lithium metal and then dried, thereby forming the electrolyte for a lithium metal battery.

The coating may be performed using any method used to form an electrolyte membrane in the art, for example, using spin coating, roll coating, curtain coating, extruding, casting, screen printing, inkjet printing, a doctor blading method, or the like.

When the electrolyte according to any of the embodiments is used in a lithium metal battery, at least one selected from a liquid electrolyte, a gel electrolyte and a solid electrolyte may be further used between a positive electrode and a negative electrode.

An organic solvent of the liquid electrolyte may include a carbonate compound, a glyme compound, and a dioxolane compound. Examples of the carbonate compound may include ethylene carbonate, propylene carbonate, dimethyl carbonate, fluoroethylene carbonate, diethyl carbonate, and ethyl methyl carbonate.

The glyme compound may be, for example, at least one selected from poly(ethylene glycol)dimethyl ether (PEGDME; polyglyme), tetra(ethylene glycol)dimethyl ether (TEGDME; tetraglyme), tri(ethylene glycol)dimethyl ether (triglyme), poly(ethylene glycol)dilaurate (PEGDL), poly(ethylene glycol)monoacrylate (PEGMA), and poly(ethylene glycol)diacrylate (PEGDA).

The dioxolane compound may be, for example, at least one selected from the group consisting of 1,3-dioxolane, 4,5-diethyl-1,3-dioxolane, 4,5-dimethyl-1,3-dioxolane, 4-methyl-1,3-dioxolane, and 4-ethyl-1,3-dioxolane. Examples of the organic solvent may include 2,2-dimethoxy-2-phenyl acetophenone, dimethyl ether (DME), 1,2-dimethoxyethane, 1,2-diethoxyethane, tetrahydrofuran, γ-butyrolactone, and 1,1,2,2-tetrafluoroethyl 2,2,3,3-tetrafluoropropyl ether.

The gel electrolyte may be any suitable electrolyte in gel form known in the art. For example, the gel electrolyte may include a polymer and a polymeric ionic liquid. For example, the polymer may be a solid graft (block) copolymer.

The solid electrolyte may be an organic solid electrolyte or an inorganic solid electrolyte. Examples of the organic solid electrolyte may include a polyethylene derivative, a polyethylene oxide derivative, a polypropylene oxide derivative, a phosphate ester polymer, a poly agitation lysine, a polyester sulfide, a polyvinyl alcohol, a polyvinylidene fluoride, and a polymer including an ionic dissociation group.

Examples of the organic solid electrolyte may include Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, Cu₃N, LiPON, Li₂S.GeS₂.Ga₂S₃, Li₂O.11Al₂O₃, (Na,Li)₁₊ₓTi₂₋ₓAlₓ(PO₄)₃ (wherein 0.1≤x≤0.9), Li₁₊ₓHf₂₋ₓAlₓ(PO₄)₃ (wherein 0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (wherein M may be a rare earth element, for example, Nd, Gd, or Dy), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (wherein X≤0.8, 0≤Y≤1.0, and M may be Nd, Sm, Eu, Gd, Tb, Dy, Ho, Er, Tm, or Yb), Li_{1+x+y}QₓTi₂₋ₓSi_{y}P_{3-y}O₁₂ (wherein 0<x≤0.4, 0<y≤0.6, and Q may be Al or Ga), Li₆BaLa₂Ta₂O₁₂, Li₇La₃Zr₂O₁₂, Li₅La₃Nb₂O₁₂, Li₅La₃M₂O₁₂ (wherein M may be Nb or Ta), and Li₇₊ₓAₓLa₃₋ₓZr₂O₁₂ (wherein 0<x<3, and A may be Zn).

According to another aspect of the present disclosure, a lithium metal battery includes: a positive electrode; a lithium metal negative electrode; and the electrolyte according to any of the embodiments between the positive electrode and the lithium metal negative electrode.

In one or more embodiments, a deposition density on a surface of the lithium metal negative electrode may be about 0.2 g/cc to about 0.3 g/cc.

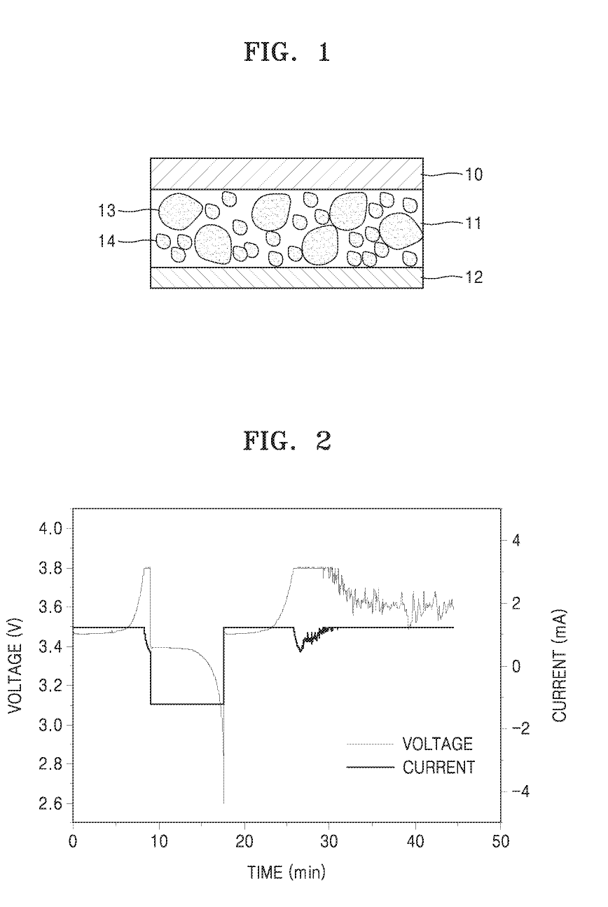

FIG. 1 is a schematic cross-sectional view illustrating a structure of a lithium metal battery according to an embodiment.

Referring to FIG. 1, an electrolyte 11 may be on a lithium metal negative electrode 12, and a positive electrode 10 may be on the electrolyte 11. As shown in FIG. 1, the electrolyte 11 may include first inorganic particles 14, and second inorganic particles 13 having a larger size than the first inorganic particles 14. For example, the first inorganic particles may have an average particle diameter of about 20 nm, and the second inorganic particles may have an average particle diameter of about 0.5 μm to about 1 μm.

For example, the lithium metal battery may be manufactured in the following manner.

First, the positive electrode may be prepared as follows.

For example, a positive active material, a conducting agent, a binder, and a solvent may be mixed to prepare a positive active material composition. The positive active material composition may be directly coated on a metallic current collector to form a positive electrode. In some embodiments, the positive active material composition may be cast on a separate support to form a positive active material film. This positive active material film may then be separated from the support and laminated on a metallic current collector to thereby form a positive electrode. The positive electrode is not limited to the above-described forms, and may be any of a variety of types.

The positive active material may be any material available in the art, for example, a lithium-containing metal oxide. In some embodiments, the positive active material may be at least one of a composite oxide of lithium with a metal selected from Co, Mn, Ni, and a combination thereof. In some embodiments, the positive active material may be a compound represented by one of the following formulae: LiₐA_{1-b}B¹_{b}D¹₂ (wherein 0.90≤a≤1.8, and 0≤b≤0.5); LiₐE_{1-b}B¹_{b}O_{2-c}D¹_{c} (wherein 0.90≤a≤1.8, 0≤b≤0.5, and 0≤c≤0.05); LiE_{2-b}B¹_{b}O_{4-c}D¹_{c} (wherein 0≤b≤0.5, and 0≤c≤0.05); LiₐNi_{1-b-c}Co_{b}B¹_{c}D¹_{α} (wherein 0.90≤a≤1.8, 0≤b≤0.5, 0≤c≤0.05, and 0<α≤2); LiₐNi_{1-b-c}Co_{b}B¹_{c}O_{2-α}F¹_{α} (wherein 0.90≤a≤1.8, 0≤b≤0.5, 0≤c≤0.05, and 0<α<2); LiₐNi_{1-b-c}Co_{b}B¹_{c}O_{2-α}F¹₂ (wherein 0.90≤a≤1.8, 0≤b≤0.5, 0≤c≤0.05, and 0<α<2); LiₐNi_{1-b-c}Mn_{b}B¹_{c}D¹_{α} (wherein 0.90≤a≤1.8, 0≤b≤0.5, 0≤c≤0.05, and 0<α≤2); LiₐNi_{1-b-c}Mn_{b}B¹_{c}O_{2-α}F¹_{α} (wherein 0.90≤a≤1.8, 0≤b≤0.5, 0≤c≤0.05, and 0<α<2); LiₐNi_{1-b-c}Mn_{b}B¹_{c}O_{2-α}F¹₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiI¹O₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the foregoing formulae above, A may be nickel (Ni), cobalt (Co), manganese (Mn), or a combination thereof; B may be aluminum (Al), nickel (Ni), cobalt (Co), manganese (Mn), chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; E may be cobalt (Co), manganese (Mn), or a combination thereof; F may be fluorine (F), sulfur (S), phosphorus (P), or a combination thereof; G may be aluminum (Al), chromium (Cr), manganese (Mn), iron (Fe), magnesium (Mg), lanthanum (La), cerium (Ce), strontium (Sr), vanadium (V), or a combination thereof; Q may be titanium (Ti), molybdenum (Mo), manganese (Mn), or a combination thereof; I may be chromium (Cr), vanadium (V), iron (Fe), scandium (Sc), yttrium (Y), or a combination thereof; and J may be vanadium (V), chromium (Cr), manganese (Mn), cobalt (Co), nickel (Ni), copper (Cu), or a combination thereof.

For example, the positive active material may be LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), or LiFePO₄.

The compounds listed above as positive active materials may have a surface coating layer (hereinafter, also referred to as “coating layer”). Alternatively, a mixture of a compound without a coating layer and a compound having a coating layer, the compounds being selected from the above-listed compounds, may be used. In some embodiments, the coating layer may include one compound of a coating element selected from the group consisting of oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the positive active material when a compound of the coating element is used. For example, the coating layer may be formed using a spray coating method or a dipping method. The coating methods may be well understood by one of ordinary skill in the art, and thus a detailed description thereof will be omitted.

In some embodiments, the conducting agent may be carbon black or graphite particulates, but embodiments are not limited thereto. Any material available as a conducting agent in the art may be used.

Examples of the binder may be a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer. However, embodiments are not limited thereto. Any material available as a binding agent in the art may be used.

Examples of the solvent may be N-methyl-pyrrolidone, acetone, and water. However, embodiments are not limited thereto. Any material available as a solvent in the art may be used.

The amounts of the positive active material, the conducting agent, the binder, and the solvent may be in ranges that are commonly used in lithium batteries. At least one of the conducting agent, the binder, and the solvent may be omitted according to the use and the structure of the lithium battery.

Next, the lithium metal negative electrode may be prepared as follows.

The lithium metal negative electrode may be a lithium metal or lithium metal ally in the form of a thin film.

The lithium metal or lithium metal alloy used as the lithium metal negative electrode may have a thickness of about 100 μm or less, for example, about 80 μm or less, for example, about 0.1 μm to about 60 μm. In some other embodiments, the lithium metal or lithium metal alloy may have a thickness of about 1 μm to about 25 μm, for example, about 5 μm to about 20 μm.

The lithium metal alloy may include a lithium metal, and a metal/metalloid alloyable with lithium metal, or an oxide thereof. Examples of the metal/metalloid allowable with lithium metal or the oxide thereof may be Si, Sn, Al, Ge, Pb, Bi, Sb, a Si—Y alloy (wherein Y may be an alkali metal, an alkali earth metal, a Group 13 element, a Group 14 element, a transition metal, a rare earth element, or a combination thereof, but not Si), a Sn—Y alloy (wherein Y may be an alkali metal, an alkali earth metal, a Group 13 element, a Group 14 element, a transition metal, a rare earth element, or a combination thereof, but not Sn), and MnOₓ (wherein 0<x≤2). For example, the element Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), chromium (Cr), molybdenum (Mo), tungsten (W), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), polonium (Po), or a combination thereof. Examples of the oxide of the metal/metalloid allowable with lithium metal may be lithium titanium oxide, vanadium oxide, lithium vanadium oxide, SnO₂, and SiOₓ (wherein 0<x<2).

Next, the electrolyte to be interposed between the positive electrode and the lithium metal negative electrode may be prepared.

In one or more embodiments, a common electrolyte available for lithium metal batteries may further be used, in addition to the electrolyte according to any of the above-described embodiments.

In one or more embodiments, the lithium metal battery may further include a liquid electrolyte.

The liquid electrolyte may include at least one selected from an organic solvent, an ionic liquid, and a lithium salt. The organic solvent may be a carbonate compound, a glyme compound, a dioxolane compound, dimethyl ether, 1,1,2,2-tetrafluoroethyl 2,2,3,3-tetrafluoropropyl ether, or the like. The organic solvent may be at least one selected from ethylene carbonate, propylene carbonate, dimethyl carbonate, diethyl carbonate, ethylmethyl carbonate, fluoroethylene carbonate, γ-butyrolactone, dimethoxyethane, diethoxyethane, dimethylene glycol dimethyl ether, trimethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, and 1,1,2,2-tetrafluoroethyl 2,2,3,3-tetrafluoropropyl ether.

In one or more embodiments, when the electrolyte is used together with a liquid electrolyte including an organic solvent such as a carbonate compound, the electrolyte according to any of the embodiments may be highly stable to the organic solvent such as a carbonate compound or to the electrolyte including the organic solvent, and thus have improved resistance to chemicals.

In one or more embodiments, the lithium metal battery may further include a separator. For example, the separator may be a monolayer of polyethylene, polypropylene, polyvinylidene fluoride, or a combination thereof, or a multilayer including at least two layers of polyethylene, polypropylene, polyvinylidene fluoride, or a combination thereof. For example, the separator may be a mixed multilayer structure, for example, a two-layer separator of polyethylene/polypropylene, a three-layer separator of polyethylene/polypropylene/polyethylene, or a three-layer separator of polypropylene/polyethylene/polypropylene. The separator may further include an electrolyte including a lithium salt and an organic solvent.

The positive electrode may be a porous positive electrode. The porous positive electrode may be a positive electrode including pores or a positive electrode which allows permeation of the liquid electrolyte into the positive electrode due to such as a capillary phenomenon.

For example, the porous positive electrode may be a positive electrode obtained by coating a positive active material composition including a positive active material, a conducting agent, a binder and a solvent, and drying the resulting structure. The thus obtained positive electrode may include pores among particles of the positive active material. The porous positive electrode may be impregnated with liquid electrolyte.

In one or more embodiments, the positive electrode may include a liquid electrolyte, a gel electrolyte, or a solid electrolyte. The liquid electrolyte, the gel electrolyte, and the solid electrolyte may be any suitable electrolyte for lithium metal batteries that does not react with the positive active material and thus prevents deterioration of the positive active material during charging and discharging.

In one or more embodiments, the lithium metal negative electrode may be a metal thin film or a lithium metal alloy thin film. The lithium metal thin film or the lithium metal alloy thin film may have a thickness of about 100 μm or less. For example, the lithium metal battery may have stable cycle characteristics even with a lithium metal thin film or a lithium metal alloy thin film each having a thickness of 100 μm or less. In the lithium metal battery according to one or more embodiments, the lithium metal thin film or the lithium metal alloy thin film may have a thickness of about 80 μm or less, for example, about 60 μm or less, and for example, about 0.1 μm to about 60 μm. However, in a lithium battery according to the related art, when a lithium metal thin film or a lithium metal alloy thin film has a small thickness of about 100 μm or less, it was not possible to manufacture the lithium battery having stable cycle characteristics due to an increased thickness of lithium deteriorated due to a side reaction, dendrite formation, or the like. However, a lithium metal battery having stable cycle characteristics may be manufactured using the electrolyte according to any of the embodiments.

The lithium metal battery according to one or more embodiments may be used in any device that requires high capacity and high output, for example, in a laptop computer, a smart phone, or an electric vehicle.

The lithium metal battery according to one or more embodiments may have improved lifetime characteristics and high rate characteristics, and thus may be used in an electric vehicle (EV), for example, in a hybrid vehicle such as a plug-in hybrid electric vehicle (PHEV). The lithium metal battery may also be used in the high-power storage field. For example, the lithium metal battery may be used in an electric bicycle or a power tool.

In one or more embodiments, the electrolyte according to any of the embodiments may further include at least one selected from an ionic liquid and a polymeric ionic liquid.

The ionic liquid may refer to a salt in a liquid state at room temperature or a fused salt at room temperature, each having a melting point equal to or below the room temperature and consisting of only ions. The ionic liquid may include: i) at least one cation selected from an ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, a triazolium cation, and a mixture(?combination) thereof; and ii) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, at least one selected from the group consisting of N-methyl-N-propylpyrrolidium bis(trifluoromethylsulfonyl)imide, N-butyl-N-methylpyrrolidium bis(3-trifluoromethylsulfonyl)imide, 1-butyl-3-methylimidazolium bis(trifluoromethylsulfonyl) imide, and 1-ethyl-3-methylimidazolium bis(trifluoromethylsulfonyl)imide.

In one or more embodiments, an amount of the ionic liquid may be about 5 parts to about 40 parts by weight, for example, about 10 parts to about 20 parts by weight, with respect to 100 parts by weight of the ion-conductive polymer. When the amount of the ionic liquid is within these ranges, the electrolyte may have improved ionic conductivity and mechanical properties.

In one or more embodiments, when the electrolyte includes an ionic liquid and a lithium salt, a molar ratio (IL/Li) of the ionic liquid (IL) to lithium ions (Li) may be about 0.1 to about 2.0, for example, about 0.2 to about 1.8, and for example, about 0.4 to about 1.5. The electrolyte according to one or more embodiments having a molar ratio within these ranges may have improved lithium ion mobility and ionic conductivity, and improved physical properties, and thus may effectively suppress the lithium dendrite growth on a surface of the negative electrode.

In one or more embodiments, the polymeric ionic liquid may include a cation selected from a poly(1-vinyl-3-alkylimidazolium) cation, a poly(1-allyl-3-alkylimidazolium) cation, and a poly(1-(methacryloyloxy-3-alkylimidazolium) cation, and an anion selected from CH₃COO⁻, CF₃COO⁻, CH₃SO₃⁻, CF₃SO₃⁻, (CF₃SO₂)₂N⁻, (FSO₂)₂N⁻, (CF₃SO₂)₃C⁻, (CF₃CF₂SO₂)₂N⁻, C₄F₉SO₃⁻, C₃F₇COO⁻, and (CF₃SO₂)(CF₃CO)N⁻.

In one or more embodiments, the polymeric ionic liquid may include a low-molecular weight polymer, a thermally stable ionic liquid, and a lithium salt. The low-molecular weight polymer may have an ethylene oxide chain. The low-molecular weight polymer may be a glyme. Examples of the glyme may include polyethyleneglycol dimethylether (polyglyme), tetraethyleneglycol dimethyl ether (tetraglyme), and triethyleneglycol dimethylether (triglyme).

In one or more embodiments, the electrolyte may have an ionic conductivity of about 1×10⁻⁴ S/cm or greater at about 25° C., for example, about 5×10⁻⁴ S/cm or greater at about 25° C., and for example, about 1×10⁻³ S/cm or greater at about 25° C. In one or more embodiments, the electrolyte may have a tensile strength of, for example, about 400 kgf/cm² to about 600 kgf/cm².

In one or more embodiments, the lithium metal battery may be, for example, a lithium air battery, a lithium ion battery, a lithium polymer battery, or a lithium sulfur battery.

The lithium metal battery according to one or more embodiments may have excellent cell performance at a high voltage. The term “high voltage” may refer to a charging voltage in a range of about 4.0 V to about 5.5 V.

One or more embodiments of the present disclosure will now be described in detail with reference to the following examples. However, these examples are only for illustrative purposes and are not intended to limit the scope of the one or more embodiments of the present disclosure.

### Preparation Example 1: Preparation of Thermoplastic Polyurethane (TPU)

Poly(diethylene glycol adipate) having a weight average molecular weight of about 3,000, and hydroquinone bis(β-hydroxyethyl)ether as a chain extender were pre-heated at about 120° C. to obtain a first mixture. 4,4′-methylenebis-(phenyl isocyanate) was melted and then mixed with the first mixture with vigorously stirring for polymerization reaction to thereby prepare poly(diethylene glycol adipate) thermoplastic polyurethane (TPU) through the reaction of the poly(diethylene glycol adipate) and the 4,4′-methylenebis-(phenyl isocyanate).

### Example 1: Manufacture of Lithium Metal Battery (Full Cell)

12.75% by weight (wt %) of the poly(diethylene glycol adipate) thermoplastic polyurethane (TPU) prepared in Preparation Example 1, 2.025 wt % of alumina having an average particle diameter of about 0.5 μm, 0.225 wt % of alumina having an average particle diameter of about 20 nm, 85 wt % of N-methyl-2-pyrrolidone (NMP) as a solvent, and a lithium salt (Lithium bis(trifluoromethanesulfonyl)imide:LiTFSl) were mixed together to obtain an electrolyte composition. An amount of the LiTFSl was about 80 parts by weight with respect to 100 parts by weight of the TPU. A mixed weight ratio of the alumina having an average particle diameter of about 0.5 μm and the alumina having an average particle diameter of about 20 nm was about 9:1.

The electrolyte composition was coated on a lithium metal thin film (having a thickness of about 20 μm) using a doctor blade to a thickness of about 5 μm. The coated resultant was dried at about 25° C. and then thermally treated in a vacuum at a temperature of about 40° C., to thereby manufacture a lithium negative electrode having an electrolyte on the lithium metal.

On the other hand, a positive electrode composition was obtained by mixing LFP(LiFePO₄), a conducting agent (Super-P; Timcal Ltd.), polyvinylidene fluoride (PVdF) and NMP. A mixed weight ratio of LFP, the conducting agent, and PVdF in the positive electrode composition was about 97:1.5:1.5.

The positive electrode composition was coated on an aluminum foil (having a thickness of about 15 μm), dried at a temperature of about 25° C., and further dried in a vacuum at a temperature of about 110° C. to thereby manufacture a positive electrode.

A polyethylene/polypropylene separator was disposed between the positive electrode obtained according to the above-described processes and a lithium metal negative electrode (having a thickness of about 20 μm) to thereby manufacture a lithium metal battery (coin cell). A liquid electrolyte was injected between the positive electrode and the negative electrode. The liquid electrolyte was an electrolyte solution of 0.8M LiTFSl dissolved in a mixed solvent of EC, EMC and DMC in a volume ratio of about 2:4:4.

### Example 2: Manufacture of Lithium Metal Battery (Full Cell)

A lithium metal battery (full cell) was manufactured in the same manner as in Example 1, except that a mixed weight ratio of the alumina having an average particle diameter of about 0.5 μm and the alumina having an average particle diameter of about 20 nm was about 20:1 in the preparation of the electrolyte composition.

### Example 3: Manufacture of Lithium Metal Battery (Full Cell)

A lithium metal battery (full cell) was manufactured in the same manner as in Example 1, except that a mixed weight ratio of the alumina having an average particle diameter of about 0.5 μm and the alumina having an average particle diameter of about 20 nm was about 15:1 in the preparation of the electrolyte composition.

### Comparative Example 1: Manufacturing of Lithium Metal Battery (Half Cell)

A lithium metal battery (half cell) was manufactured in the same manner as in Example 1, except that the electrolyte composition was prepared in the following manner.

12.75 wt % of the poly(diethylene glycol adipate) thermoplastic polyurethane (TPU) prepared in Preparation Example 1, 2.25 wt % of alumina having an average particle diameter of about 0.5 μm, 85 wt % of NMP as a solvent, and 85 wt % of LiTFSl as a lithium salt were mixed together to obtain an electrolyte composition. An amount of the LiTFSl was about 80 parts by weight with respect to 100 parts by weight of the TPU.

### Comparative Example 2: Manufacture of Lithium Metal Battery (Full Cell)

A lithium metal battery (full cell) was manufactured in the same manner as in Example 1, except that alumina having an average particle diameter of about 0.6 μm and the alumina having an average particle diameter of about 90 nm were used instead of alumina having an average particle diameter of about 0.5 μm, and alumina having an average particle diameter of about 20 nm, and a mixed weight ratio of the alumina having an average particle diameter of about 0.6 μm and the alumina having an average particle diameter of about 90 nm was about 7:1 in the preparation of the electrolyte composition.

### Comparative Example 3: Manufacture of Lithium Metal Battery (Full Cell)

A lithium metal battery (full cell) was manufactured in the same manner as in Example 1, except that alumina having an average particle diameter of about 0.6 μm and the alumina having an average particle diameter of about 90 nm were used instead of alumina having an average particle diameter of about 0.5 μm, and alumina having an average particle diameter of about 20 nm, and a mixed weight ratio of the alumina having an average particle diameter of about 0.6 μm and the alumina having an average particle diameter of about 90 nm was about 4:1 in the preparation of the electrolyte composition.

### Evaluation Example 1: Charge and Discharge Characteristics (Voltage Profile and Capacity Retention)

### 1) Example 1 and Comparative Example 1

Each of the lithium metal batteries (full cells) manufactured in Example 1 and Comparative Example 1 was charged at a temperature of 25° C. with a constant current of 0.2 C rate until a voltage of 3.80 V (with respect to Li) was reached and then with a constant voltage of 3.80 V (constant voltage mode) until a cutoff current of 0.05 C rate was reached. Then, each of the lithium metal batteries was discharged with a constant current of 0.2 C rate until a voltage of 2.6 V (with respect to Li) was reached (Formation process, 1^{st} cycle). This charging and discharging process were performed two times more to thereby complete the formation process.

Each of the lithium metal batteries which went through the formation process was charged and discharged at room temperature (25° C.) under the following conditions.

Charging: 3.8V, 0.5 C CC/CV, Cutoff 0.05 C

Discharging: 0.5 C CC, Cutoff 2.6V

The above-described charging and discharging process was repeatedly performed. An initial capacity of each of the lithium metal batteries after the 1^{st} cycle and a capacity retention after the 10^{th} cycle were evaluated. The results are shown in Table 1.

The capacity retention was defined as a percentage (%) of a discharge capacity at the 10^{th} cycle to a discharge capacity at the 1^{st} cycle.

TABLE 1

| Example | Initial capacity | Capacity retention (@ 10^{th} cycle) |
|---|---|---|
| Example 1 | 98.5 | 98.9 |
| Comparative | 98.4 | Short occurred |
| Example 1 | | |

Referring to Table 1, the lithium metal battery of Example 1 was found to have improved initial capacity and capacity retention, as compared with the lithium metal battery of Comparative Example 1.

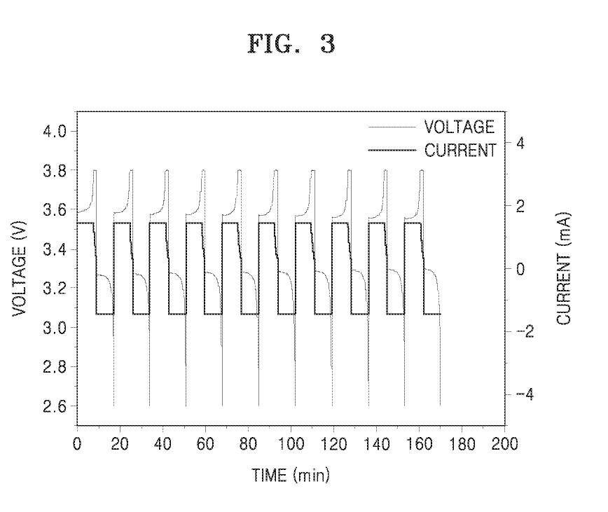

Changes in voltage and current of the lithium metal batteries manufactured in Example 1 and Comparative Example 1 were evaluated. The results are shown in FIGS. 2 and 3.

Referring to FIG. 2, in the lithium metal battery of Comparative Example 1, a short occurred due to dendrite at the 2^{nd} cycle after the normal 1^{st} cycle of charging and discharging.

Referring to FIG. 3, unlike the lithium metal battery of Comparative Example 1, the lithium metal battery of Example 1 was found to maintain a normal charge-and-discharge cycle state up to the 10^{th} cycle, indicating that a short caused due to dendrite was improved in the lithium metal battery of Example 1, as compared with the lithium metal battery of Comparative Example 1.

### 2) Example 2 and Comparative Example 2

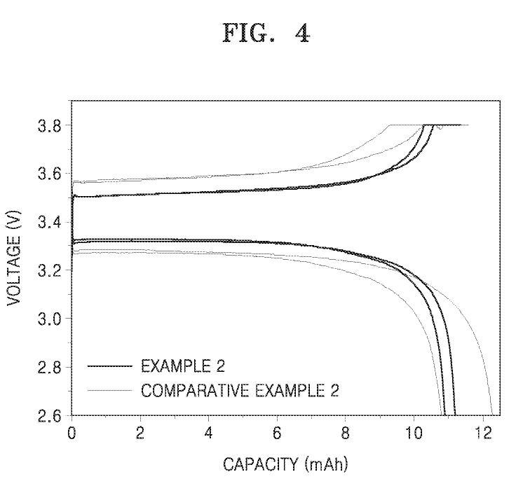

Each of the lithium metal batteries (full cells) manufactured in Example 2 and Comparative Example 2 was evaluated using a charge/discharge profile analysis method. The results are shown in FIG. 4.

The Charging and Discharging Conditions were as Follows.

Charging: 0.2 C-CC/CV 3.8V, 0.05 C Cutoff

Discharging: 0.2 C-CC, 2.6V

Referring to FIG. 4, the lithium metal battery of Comparative Example 2 was found to have a remarkably reduced capacity at the 2^{nd} cycle, unlike at the 1^{st} cycle, indicating that overvoltage (resistance) increases with an increasing number of cycles.

However, the the lithium metal battery of Example 2 was found to suppress increase of overvoltage increase, as compared with as the lithium metal battery of Comparative Example 2.

A capacity retention of the lithium metal battery of Example 3 was evaluated in the same manner as applied to evaluate the capacity retention of the lithium metal battery of Example 1. As a result, the lithium metal battery of Example 3 was found to have the same level of capacity retention as that of the lithium metal battery of Example 1.

### Evaluation Example 2: Deposition Density

After each of the lithium metal batteries of Examples 1 and 2 and Comparative Examples 1 and 2 was charged at a temperature of about 25° C. with a constant current of 0.1 C rate until a voltage of 4.30 V (with respect to Li) was reached, a deposition density on lithium surface in each of the lithium metal batteries was evaluated.

As a result of the deposition density evaluation, the lithium metal batteries of Examples 1 and 2 were found to have increased deposition densities, as compared with the lithium metal batteries of Comparative Examples 1 and 2. Accordingly, the lithium metal batteries of Examples 1 and 2 were found to have an improved lithium dendrite suppression effect, as compared with the lithium metal batteries of Comparative Examples 1 and 2.

While one or more embodiments have been described with reference to the appended drawings, it will be understood by those of ordinary skill in the art that various changes in form and details may be made therein without departing from the spirit and scope as defined by the following claims. Therefore, the scope of the disclosure is defined by the appended claims, not by the detailed description of the present disclosure.

### INDUSTRIAL APPLICABILITY

As described above, according to the one or more embodiments, an electrolyte for a lithium metal battery may effectively suppress lithium dendrite growth on a surface of the lithium metal negative electrode, thus leading to a reduced lithium deposition density. As a result, a lithium metal battery having improved lifespan may be manufactured using the electrolyte.

1. An electrolyte for a lithium metal battery, the electrolyte comprising:
first inorganic particles having an average size of about 10 nm to about 100 nm;
second inorganic particles having an average size larger than the average size of the first inorganic particles;
an ion-conductive polymer; and
a lithium salt,
wherein a size ratio of the first inorganic particles to the second inorganic particles is about 1:9 to about 1:20.

2. The electrode of claim 1, wherein the average size of the second inorganic particles is about 300 nm to about 3000 nm.

3. The electrode of claim 1, wherein the first and second inorganic particles comprise at least one selected from Al₂O₃, TiO₂, BaTiO₃, Li₂O, LiF, LiOH, Li₃N, BaO, Na₂O, Li₂CO₃, CaCO₃, LiAlO₂, SiO₂, SiO, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, Sn₂BPO₆, a cage-structured silsesquioxane, and a metal-organic framework (MOF).

4. The electrode of claim 1, wherein a total amount of the first inorganic particles and the second inorganic particles is about 1 part to about 40 parts by weight with respect to 100 parts by weight of the ion-conductive polymer.

5. The electrode of claim 1, wherein the ion-conductive polymer is at least one selected from the group consisting of polyvinylidene fluoride (PVDF), polyethylene oxide (PEO), polymethylene methacrylate (PMMA), and thermoplastic polyurethane (TPU).

6. The electrode of claim 1, wherein the lithium salt is at least one selected from LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein x and y are natural numbers), LiCl, and LiI.

7. The electrode of claim 1, wherein the electrolyte further comprises at least one selected from an organic solvent, an ionic liquid, and a polymeric ionic liquid.

8. The electrode of claim 1, wherein the electrolyte has a thickness of about 1 μm to about 20 μm.

9. The electrode of claim 1, wherein the average size of the first inorganic particles is about 20 nm, and the average size of the second inorganic particles is about 0.4 μm to 0.5 μm.

10. A lithium metal battery comprising:
a positive electrode;
a lithium metal negative electrode; and
the electrolyte according to claim 1 between the positive electrode and the lithium metal negative electrode.

11. The lithium metal battery of claim 10, wherein a deposition density of lithium on a surface of the lithium metal negative electrode is about 0.2 g/cc to about 0.3 g/cc.
